(19) United States
(12) Patent Application Publication
(10) Pub. No.: US 2006/0156887 A1
(43) Pub. Date: Jul. 20, 2006

(54) Circular saw guard and foot

(76) Inventor: Robert Hutchings, Henderson, NV (US)

Correspondence Address: KRAJEC PATENT OFFICES, LLC, 820 WELCH AVENUE, BERTHOUD, CO, 80513, US

(21) Appl. No.: 11/036,879

(22) Filed: Jan. 14, 2005

(51) Int. Cl. B26D 5/08

(52) U.S. Cl. 83/581

(57) ABSTRACT

A large capacity circular saw that is relatively lightweight yet has a very wide foot for greater stability and ease of use. The guards and foot for the saw may be made from magnesium for light weight but also strength and durability. The foot is wide enough so that it extends sufficiently past the saw motor body on the side opposite the blade so that a common 2×4 or other dimensional lumber may be used as a guide. Additionally, the foot may be adjustable to regulate the depth of cut as well as the angle of cut. The range of the angle of cut is 90-40 degrees.

### BACKGROUND OF THE INVENTION

a. Field of the Invention

The present invention pertains generally to circular saws and more specifically to guards used in hand held circular saws.

b. Description of the Background

Portable circular saws are one of the most used tools on a typical wood frame construction jobsite. An electric motor turns a rotating circular blade at high speed for cutting lumber of all sorts, such as studs, beams, sheathing, plywood, and any other lumber.

Typically, such saws have a two piece guard with a fixed upper guard that is attached to the motor and a moving guard that exposes the blade during a cutting operation. Further, such saws generally have a guide foot that rides on a surface of the lumber to be cut. The foot generally positions the blade with respect to the surface and slides in the direction of the cut.

The typical size saw has a 7.25 in diameter blade. Such saws are generally able to cut standard dimension 2× lumber, such as a 2×4, 2×6, etc., by cutting on the small dimension, which is typically 1.5 in thick.

Larger capacity saws exist that have 10 in or larger diameter blades. Larger sized saws are generally heavier due to the shear size but also the increased motor size. Heavier saws can become unwieldy, create fatigue in the operator, and become a safety hazard in certain situations.

It would therefore be advantageous to provide a large capacity saw that is easier to handle. It would be further advantageous to provide such a saw that were able to be used safely in more situations than previous designs.

### SUMMARY OF THE INVENTION

The present invention provides a large capacity saw that is relatively lightweight yet has a very wide foot for greater stability and ease of use. The guards and foot for the saw may be made from magnesium for light weight as well as strength and durability. The foot is wide enough so that it extends sufficiently past the saw motor body on the side opposite the blade so that a common 2×4 or other dimensional lumber may be used as a guide. Additionally, the foot may be adjustable to regulate the depth of cut as well as the angle of cut. The range of the angle of cut is 90-40 degrees.

### BRIEF DESCRIPTION OF THE DRAWINGS

In the drawings,

FIG. 1 is a perspective illustration of a circular saw from the left hand side.

FIG. 2 is a perspective illustration of a circular saw from the lower right hand side, showing a reversible handle mounted to the right side of the upper guard.

FIG. 3 is a perspective illustration of a circular saw adjusted for a minimum depth of cut.

FIG. 4 is a perspective illustration of a circular saw adjusted for an angled cut that is 50 degrees from vertical.

FIG. 5 is a perspective illustration of a circular saw with a guide fence on the right side.

FIG. 6 is a perspective illustration of a circular saw with a guide fence on the left side.

### DETAILED DESCRIPTION OF THE INVENTION

Specific embodiments of the invention are described in detail below. The embodiments were selected to illustrate various features of the invention, but should not be considered to limit the invention to the embodiments described, as the invention is susceptible to various modifications and alternative forms. The invention is to cover all modifications, equivalents, and alternatives falling within the spirit and scope of the invention as defined by the claims. In general, the embodiments were selected to highlight specific inventive aspects or features of the invention.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement. “Comprising” leaves open for the inclusion of unspecified ingredients even in major amounts.

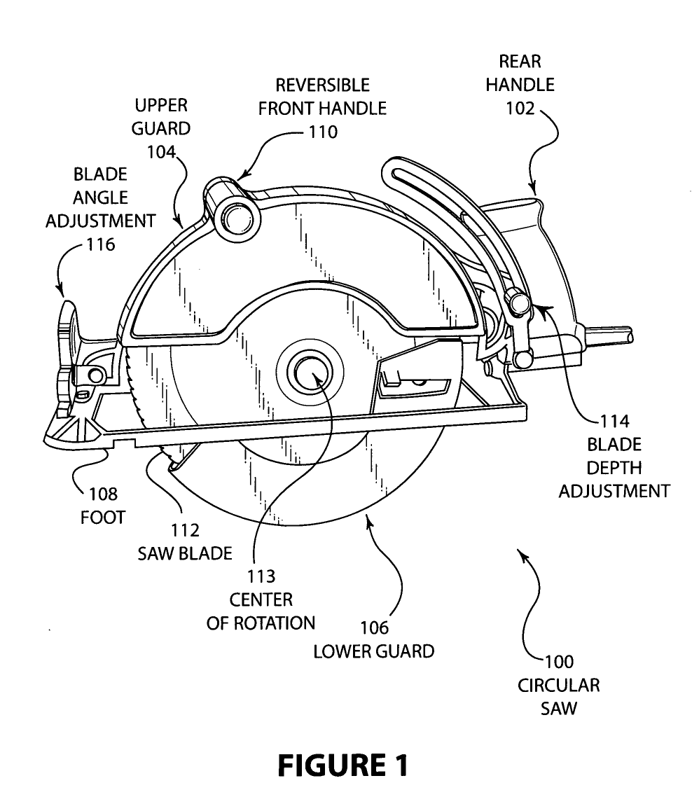

FIG. 1 is a perspective view of an embodiment 100 of a circular saw. The saw has a rear handle 102, an upper guard 104, a movable lower guard 106, a foot 108, a reversible front handle 110, and a saw blade 112. Additionally, a blade depth adjustment 114 and a blade angle adjustment 116 enable depth of cut and angle of cut adjustments, respectively.

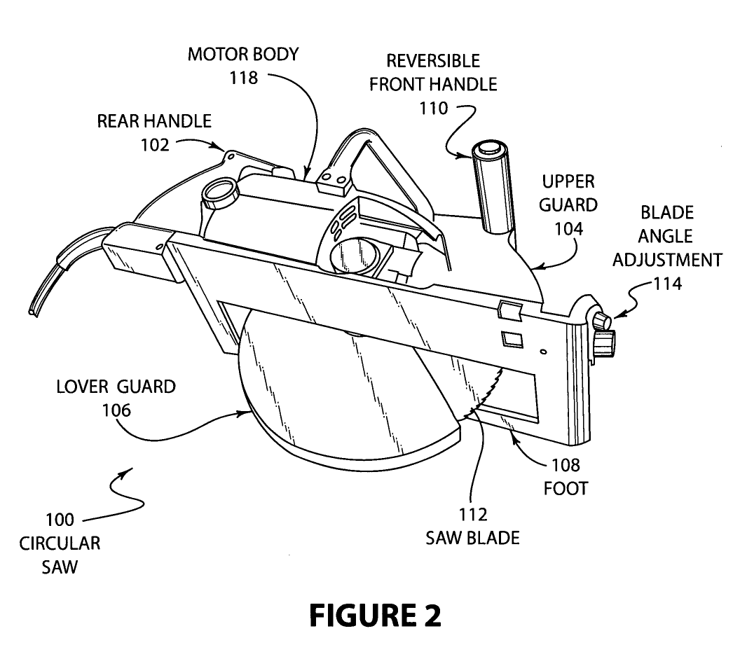

FIG. 2 is a perspective view of the bottom of embodiment 100 of a circular saw. Illustrated in this figure are a rear handle 102, an upper guard 104, a movable lower guard 106, an adjustable foot 108, and a motor body 118. The foot 106 is adjustable in part by the blade angle adjustment 114.

The embodiment 100 is a hand held portable circular saw. An operator may grasp the saw using the rear handle 102 and the front handle 110, position the foot 108 on a surface of a material to be cut, and move the saw forward as the cut progresses. In the view shown in FIG. 1, the saw blade typically rotates in a clockwise rotation and the saw would progress to the left as a cut is made.

Various types of blades may be used for different cutting materials. For example, several types of commercially available blades are used for cutting wood, including rip blades, crosscut blades, combination blades, and other blades with specific geometries designed to cut various types of wood and wood products. In other embodiments, diamond tipped blades or carbide blades may be used for cutting asphalt, concrete, stone, glass, metal, or other substances. In still other embodiments, any type of circular rotating blade may be used to cut various materials. While virtually any material suitable for cutting may be cut with such a saw, references to wood, lumber, or other material to be cut shall be deemed to include any material possible to be cut by such a device. Any reference to wood or wood products shall be only for purposes of illustration and not limitation.

The saw blade 112 has a center of rotation 113 about which the blade 112 revolves. The blade 112 may attach directly to a motor spindle at the center of rotation 113 or may be connected through a gear box such as a worm drive. A direct drive circular saw may be useful in embodiments having lower cost or lower power. Worm drive embodiments may be useful where a gear reduction is desired between the motor and the saw blade. Such embodiments may tend to be more rugged and powerful, but also may be heavier and more costly.

The embodiment 100 is an example of a worm drive configuration. The motor body 118 contains a motor that has a shaft that is 90 degrees from the axis of rotation for the saw blade.

The saw blade 112 may attach to the motor spindle through various coupling mechanisms. In some embodiments, a saw blade may have a circular or diamond shaped hole through which a bolt is fastened. Various washers and clamps may also be used. Other embodiments may use any useful method for attaching a blade 112 to a motor shaft. Typically, the blade 112 may be readily replaceable, however a permanently mounted blade is also envisioned for the present invention.

A blade 112 may be defined by a plane that is perpendicular to the axis of rotation. In many embodiments, a blade may be manufactured from sheet steel or other suitable material with cutting edges brazed at intervals around the outer edge of the blade. In other embodiments, the blade may be manufactured from an abrasive molded onto a carrier, such as various commercially available blades used for cutting concrete or metal.

The upper guard 104 is rigidly connected to the body of the saw, whereas the lower guard 106 is rotatable in a counter clockwise motion as viewed in FIG. 1, so that the saw blade 112 can be fully exposed below the foot 108. The lower guard 106 may have a spring return or other mechanism that keeps the lower guard 106 in the lowered position as shown. The lower guard 106 may be capable of surrounding the blade 112 while the blade 112 is moving, allowing an operator to set the saw 100 on the ground while the blade 112 is moving without endangering the surface on which it sits.

The foot 108 may be adjustable in several ways. The blade depth adjustment 114 may enable the foot 108 to be rotated and thereby limit the amount of exposed saw blade 112. Similarly, the blade angle adjustment 116 may enable the foot 108 to be rotated along its primary axis to adjust the angle of the cut. In the present illustration, the foot 108 is set to 90 degrees from the plane of the saw blade 112.

The upper guard 104, lower guard 106, and foot 108 may be manufactured from several materials, such as cast or fabricated aluminum, steel, or in some cases various plastics including reinforced moldable plastics. In other embodiments, these items may be manufactured from magnesium. Magnesium offers better weight properties than other metals and can be cast and machined with relative ease.

In embodiments for large diameter saw blades, the weight of the entire saw 100 can become an ergonomic and safety issue. Repeated lifting and maneuvering of a large saw can be fatiguing. For many portable saws with blades below 7 inches diameter, the saw may be operated comfortably with one hand. Some saws with blades between 7 and 9 inches may preferably require two hands but may at some times be operated with one. Other saws of that size, including worm drive versions, may require two hands for almost all operations. Most saws above 9 inch diameter require two hands, and these very large saws tend to be quite fatiguing to operate. Embodiment 100 is an example of a saw with a 10.25 inch blade.

Weight of a portable saw is a very big safety issue. Not only are portable saws prone to being dropped on occasion, but their use sometimes requires the operator to stretch over a large piece of lumber or plywood while operating the saw. When stretched out over a sheet of plywood, the operator may have great difficulty in maneuvering and lifting a saw. If an operating saw with a very high speed blade driven by a powerful motor is mishandled, the potential for personal injury and collateral damage is severe.

For large capacity saws, such as those over 9 inch diameter, the size of the various guarding components of the saw can make up much of the overall weight of the saw. Conversely, for smaller size saws, the motor and windings make up a proportionately larger share of the saw weight. Even though a larger size saw may have a larger and heavier motor, the shear size of the guards and foot of the larger saw contribute an even larger portion of the overall weight than for a smaller size saw.

Thus, especially for large capacity saws, the upper guard 104, lower guard 106, and foot 108 may be manufactured from magnesium, including cast, machined, or fabricated magnesium. In many cases, each of the upper guard 104, lower guard 106, and foot 108 may be manufactured as single cast magnesium pieces. In other embodiments, one or more of these items may be built up from several individual pieces of cast or machined magnesium and fastened together using fasteners or other joining technology.

The reversible handle 110 is illustrated in FIG. 1 as mounted on the left side of the upper guard 104 while the same handle is shown in FIG. 2 as mounted on the right side. The handle 110 may be mounted to the upper guard 104 directly by any suitable method, including threaded engagement. In the present embodiment, the handle 110 may be a unitized design having a male threaded portion that is adapted to engage a female threaded portion of the upper guard 104. In such an embodiment, the handle 110 may be unscrewed from one position and reengaged in another with or without the use of tools. In other embodiments, various connection methods may be used by those skilled in the arts while keeping within the spirit and intent of the present invention.

The embodiment 100 may be designed so that the operator may place either hand on either handle. When the reversible handle is to the left, as in FIG. 1, an operator may find it comfortable to hold the saw 100 by using the left hand on the forward reversible handle 110 and the right hand on the rear handle 102. With the reversible handle 110 on the right, as in FIG. 2, an operator may prefer to hold the saw 100 with the right hand on the forward handle 110 and the left hand on the rear handle 102. In some situations, however, the operator may use the saw with either hand on either handle, regardless of the position of the reversible front handle 110.

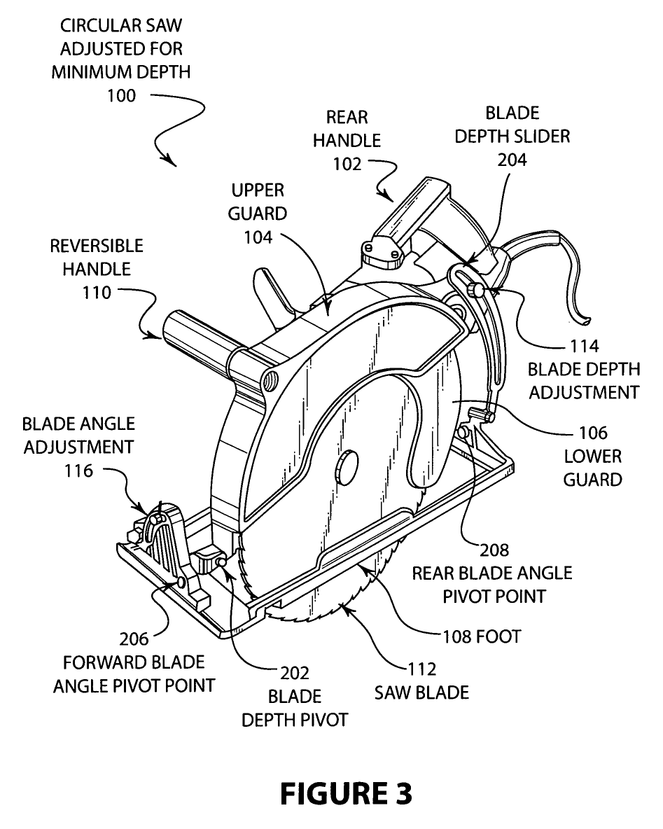

FIG. 3 is a perspective view of the embodiment 100 of a circular saw wherein the foot is adjusted for small depth of cut. The saw 100 has a rear handle 102, an upper guard 104, a lower guard 106 that is shown partially retracted, a foot 108, and a reversible handle 110 shown in the right hand position.

The saw blade 112 is shown at the minimum depth of cut. The depth of cut is adjusted by pivoting the foot 108 about the pivot 202. The slider 204 allows the adjustment 114 to move along the slider and clamp in place.

When the saw 100 is adjusted for a minimum depth of cut, the body of the saw, including the saw motor and rear handle 102, is rotated upwards so that only a small portion of the saw blade engages the material to be cut. Such a feature is useful when cutting a thin piece of material or when obstacles, supports, or other hazards may be struck if the saw were used at the full depth. In other cases, a slot may be cut at a predetermined depth by adjusting the relative position of the foot 108.

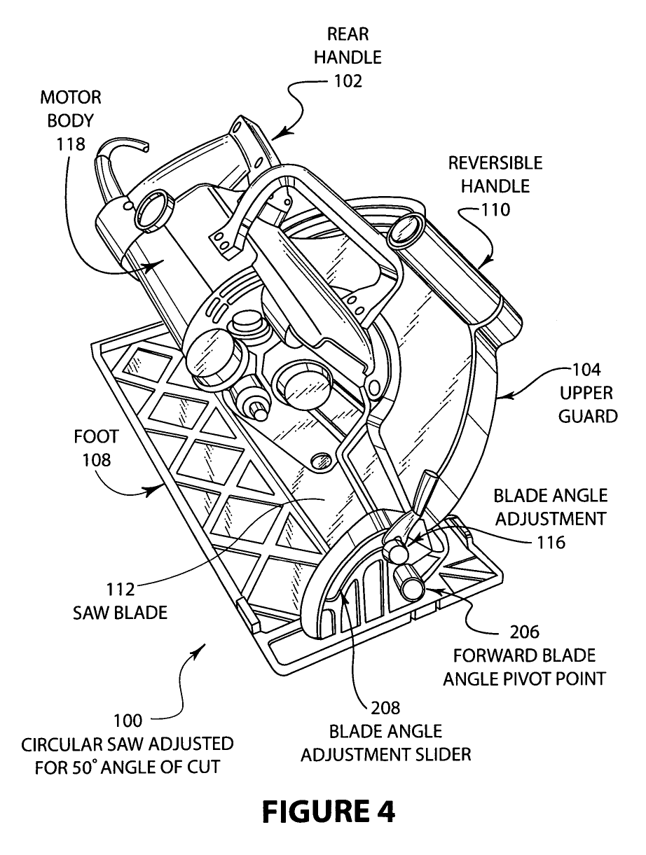

FIG. 4 is a perspective view of the embodiment 100 of a circular saw wherein the saw is adjusted for an oblique angle of cut that is 50 degrees from normal. The figure shows the rear handle 102, the upper guard 104, the foot 108, and the motor body 118.

The angle of cut is adjusted by loosening the blade angle adjustment 116 that is mounted in the blade angle adjustment slider 208, and pivoting the saw with respect to the foot 108 by the pivot point 206. A second corresponding pivot point is not shown in the rear of the foot 108. When the angle of cut is adjusted to the preferred position, the adjustment 116 may be tightened to secure the saw position with respect to the foot 108.

In some embodiments, a scale may be marked on the slider 208 to indicate the current angle setting. A corresponding pointer or indicator may be attached to a pivoting portion of the assembly and display the angle.

The present embodiment 100 illustrates a cut angle that is at least 50 degrees from vertical. The resulting cut will be 40 degrees from the horizontal bottom plane of the foot 108. In some prior art saws, the maximum angle of deviation from 90 degrees is 45, if any adjustment at all were available. When a saw is adjusted to cut at oblique angles, the depth of cut during an angled cut is limited. Hence, larger angles of cut are more useful in larger sized saws. In the present example, a 10¼ inch blade still has plenty of useful depth of cut, even when used at a 50 degree angle of cut. In other saws with smaller diameter blades, a 50 degree cut angle may provide very little useful cutting depth.

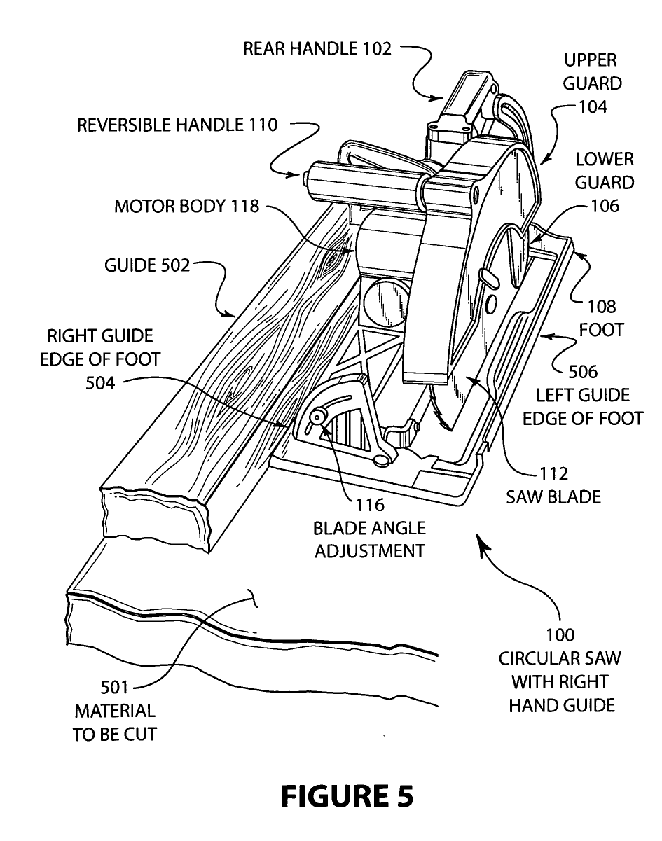

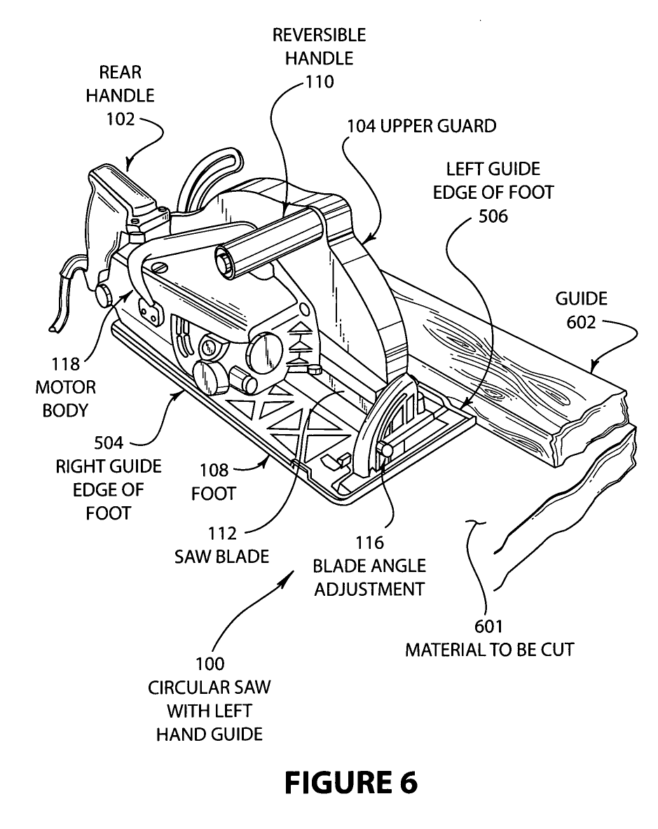

FIGS. 5 and 6 illustrate the use of the saw 100 with guide fences.

FIG. 5 illustrates the saw 100 being used with a 2×4 guide fence 502 along the right hand side of the saw 100. The saw 100 comprises a rear handle 102, an upper guard 104, a lower guard 106 in a retracted position, a foot 108 positioned in the maximum depth and 90 degree angle of cut positions, a saw blade 112, and a motor body 118.

The guide 502 shown is a dimensional 2×4, which typically measures 1.5 inches×3.5 inches. The right edge 504 of the foot 108 is able to slide along the guide 502 during the cutting process. The guide 502 enables the operator to make a quick, accurate cut.

The edge 504 may be designed to slide against the guide 502. The points or surfaces of the edge 504 that come in contact with the guide 502 may be substantially parallel to the plane of rotation of the saw blade 112. Because the guide surface, in this case edge 504, is substantially parallel to the plane in which the saw blade 112 rotates, the opportunity for binding the saw with the material being cut is greatly reduced.

The width of the foot 108 is such that the edge 504 extends past the motor body 118 so that the guide 502 does not interfere with the motor body 118. In some prior art saws, the width of the foot 108 may be used as a guide, but only a very thin guide could be used, since the motor body 118 would interfere with the guide.

The embodiment 100 is able to use a common sized piece of lumber as guide 502 because the edge 504 extends sufficiently past the motor body 118. Because a common sized piece of lumber can be used for a guide, the cost of having a special guide is avoided. Further, a jobsite may have many pieces of 2× dimensional lumber available, making any one of those pieces of lumber available as a guide. In many cases, a 2×4 or other 2× dimensional lumber may be clamped or temporarily nailed to the material to be cut 501 to serve as a guide 502.

FIG. 6 illustrates saw 100 being guided against a guide 602 that is mounted on the left side of the saw, as viewed from the operator's perspective. The saw 100 comprises a rear handle 102, and upper guard 104, a foot 108, and a motor body 118.

The left edge 506 of the foot 108 is able to slide against the guide 602 to direct the path of the saw. The points or surfaces of the edge 506 that come in contact with the guide 602 may be substantially parallel to the plane of rotation of the saw blade 112. Because the guide surface, in this case edge 506, is substantially parallel to the plane in which the saw blade 112 rotates, the opportunity for binding the saw with the material being cut is greatly reduced.

When the guide 502 is used along the right side of the saw, as in FIG. 5, the guide is mounted to the portion of the material that supports the weight of the saw. A much larger portion of the weight of the saw is over the side of the foot 108 that is to the right of the blade 112, as viewed by the operator. When a cut is completed, it may be preferred to have the right hand portion of the sawn material to be supported while the left had portion may be allowed to fall away as the cut is completed. If the left hand portion were supported, the operator may support the weight of the saw to prevent the saw from binding and to complete the cut properly.

Thus, one of the safest positions of operation is when the right side of the material to be cut is supported. In such a case, the weight of the saw is supported by the foot 108 resting on the cut material throughout the cutting process, including after the cut is complete. The operator therefore does not have to support the weight of the saw.

Since the right hand side of the material to be cut is preferred to be supported, it may also be the preferred side to mount a guide. A guide mounted on the left, such as guide 602 in FIG. 6, may be on an unsupported portion of the sawn material. In some cases, the unsupported material may be very small and not afford enough space onto which a guide may be mounted. In other cases, a clamping or holding mechanism for the guide may be damaged if the left hand portion of the material were allowed to fall after the cut is complete.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A circular saw comprising:
a motor having a motor shaft and a motor body;
a saw blade connected to said motor shaft and having a plane of rotation;
a foot connected to said motor body and having:
a bottom surface substantially flat and adapted to slide on a surface of an article to be cut;
a first guide edge being parallel to said plane of rotation and being opposite said saw blade from said motor body; and
a second guide edge being parallel to said plane of rotation and extending beyond said motor body from said saw blade such that a guide at least 1.5 inches thick placed on said surface of said article to be cut does not interfere with said motor body; and
an upper guard fixedly connected to said motor body;
a lower guard movably connected to said motor body and operable to expose a portion of said saw blade.

2. The saw of claim 1 further comprising a worm drive such that an axis of rotation of said motor shaft is perpendicular to an axis of rotation of said saw blade.

3. The saw of claim 1 wherein said upper guard comprises magnesium.

4. The saw of claim 1 wherein said lower guard comprises magnesium.

5. The saw of claim 1 wherein said foot comprises magnesium.

6. The saw of claim 1 wherein said foot is a minimum of 6 inches wide.

7. The saw of claim 1 further comprising:
a handle connected to said upper guard.

8. The saw of claim 7 wherein said handle is adapted to be connected in at least two positions.

9. The saw of claim 8 wherein said handle is adapted to be connected on opposite sides of said saw blade.

10. A method for manufacturing a circular saw comprising:
providing a motor having a motor shaft and a motor body;
connecting a saw blade said motor shaft, said saw blade having a plane of rotation;
connecting a foot to said motor body, said foot having:
a bottom surface substantially flat and adapted to slide on a surface of an article to be cut;
a first guide edge being parallel to said plane of rotation and being opposite said saw blade from said motor body; and
a second guide edge being parallel to said plane of rotation and extending beyond said motor body from said saw blade such that a guide no less than 1.5 inches thick placed on said surface of said article to be cut does not interfere with said motor body; and
fixedly connecting an upper guard to said motor body;
movably connecting a lower guard to said motor body, said lower guard being operable to expose a portion of said saw blade.

11. The method of claim 10 further comprising connecting a worm drive such that an axis of rotation of said motor shaft is perpendicular to an axis of rotation of said saw blade.

12. The method of claim 10 wherein said upper guard comprises magnesium.

13. The method of claim 10 wherein said lower guard comprises magnesium.

14. The method of claim 10 wherein said foot comprises magnesium.

15. The method of claim 10 wherein said foot is a minimum of 6 inches wide.

16. The method of claim 10 further comprising connecting a handle to said upper guard.

17. The method of claim 16 wherein said handle is adapted to be connected in at least two positions.

18. The method of claim 17 wherein said handle is adapted to be connected on opposite sides of said saw blade.
